(19) United States
(12) Patent Application Publication
(10) Pub. No.: US 2003/0150122 A1
(43) Pub. Date: Aug. 14, 2003

(54) Liquid level system

(76) Inventor: Stephen C. Brinton, Glendale, CA (US)

Correspondence Address: John A. Scillieri, 10940 Wilshire Boulevard, 18th Floor, Los Angeles, CA, 90024, US

(21) Appl. No.: 10/071,720

(22) Filed: Feb. 8, 2002

(51) Int. Cl. G01C 9/32

(52) U.S. Cl. 33/348

(57) ABSTRACT

A liquid level system comprising: a frame having a measuring surface; an observation tube having a first end, a central portion and a second end and a longitudinal axis, the observation tube being filled with a liquid sufficient to create a positioning bubble within the observation tube and the observation tube mounted to the frame such that the longitudinal axis of the observation tube is at a predetermined angle relative to the measuring surface; a first light source mounted to said frame in a position such that the light emitted from the first light source is directed at the observation tube; an electric power source affixed to said frame and electrically connected to form a circuit with the first light source for energizing the first light source.

### BACKGROUND OF THE INVENTION

1. Field of the Invention

The present invention relates to tools used by carpenters, masons, constructions workers and others and, more particularly, to an apparatus for determining the level of edges, surfaces, objects and other items or points of reference relative to the ground in conditions which makes visual perception difficult. The invention may also be utilized by non-professionals who require a determination of the relative level of edges, surfaces, objects and other items or points of reference.

2. Description of the Prior Art

Several types of devices are available which are capable of determining the relative level of edges, surfaces, objects and other items or points of reference and, in particular, of determining if such tangible objects and points of reference are at the same level relative to the earth by utilizing gravity to make such a determination. A common type of device is the carpenter's spirit level which has at least one measuring edge or surface and one or more transparent observation tubes parallel, perpendicular and/or at a predetermined angle relative to the measuring edges or surface. The observation tubes or tubes are substantially, although not completely, filled with liquid, thus allowing a bubble to be formed within the observation tube and observed through the transparent tube. Thus, when the tube is parallel to the earth, gravity causes the bubble to be centered within the tube. Thus, when the measuring edge or surface is parallel, perpendicular or at a predetermined angle (as the case may be) to the earth surface, the bubble is centered within the observation tube.

Such spirit levels presently suffer from the disadvantage that they are generally difficult to read, and very difficult to read under low light and/or dusty conditions. It is not unusual for such levels to be utilized in areas which have no light or low light and in areas which have substantial amounts of air-borne dust caused by construction activity and the like. Such level devices are also difficult for people with poor or failing eyesight to utilize. Accordingly, and particularly when utilized under the aforesaid adverse conditions, the operator will make at times an error.

There is accordingly a need for a leveling measuring system that overcomes the disadvantages in the prior art; namely, a device which is capable of being easily read and observed under low light and such adverse conditions and, preferably, of low cost.

### SUMMARY AND OBJECTS OF THE INVENTION

The above-mentioned problems in the prior art have been overcome by the present invention which fulfills the stated requirements. The present invention is a level system utilizing a light source to enable the operator to make accurate observations of the observation tube and bubble position.

A general object of the invention is to provide a commercially level system for utilization by carpenters, masons, constructions workers and the general public.

A primary object of the invention is to provide a level system which is simply constructed and economical to produce.

Yet another object of the invention is to provide a level system which is reliable and which may be used by those with no technical or construction background.

Still another aspect of the invention is to provide a level system which may be manufactured at a cost comparable to level systems in the prior art. Other objects and advantages of the invention will appear from the following description of the preferred embodiment, of which the accompanying drawings form a part.

### BRIEF DESCRIPTION OF THE DRAWINGS

FIG. 1 is a front elevational view of a preferred embodiment of my spirit level system;

FIG. 2 is a side elevational view of a preferred embodiment of my spirit level system;

FIG. 3 is a bottom plan view of a preferred embodiment of my spirit level system;

FIG. 4 is a front elevational view in partial diagrammatic form of my spirit level system;

FIG. 5 is a bottom plan view in partial diagrammatic form of the embodiment of FIG. 4;

FIG. 6 is a front elevational view in partial diagrammatic form of an alternative embodiment of my spirit level system; and

FIG. 7 is a bottom plan view of the embodiment of my invention shown in FIG. 6.

### DESCRIPTION OF THE PREFERRED EMBODIMENTS

While the present invention is susceptible to modifications and alternative constructions, illustrative embodiments are shown in the drawings and will be described in detail herein below. It should be understood, however, that it is not the intention to limit the invention to the particular form disclosed; but, on the contrary, the intention is to cover all modifications, equivalences and alternative constructions falling within the spirit and scope of the invention as expressed in the appended claims.

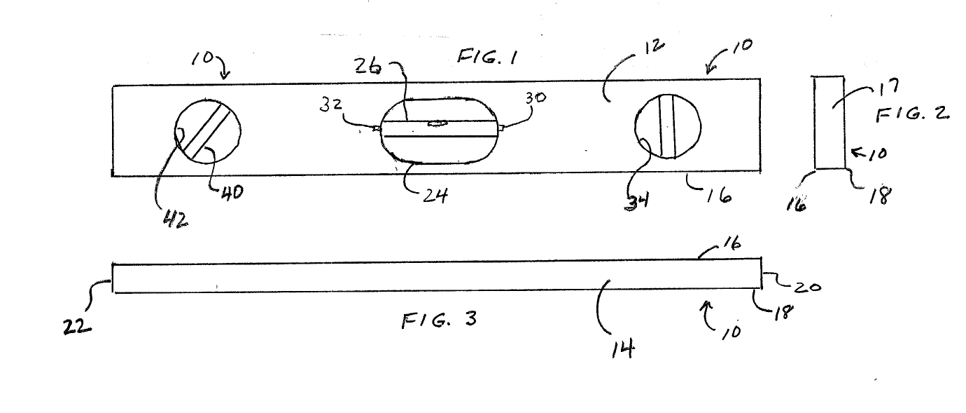

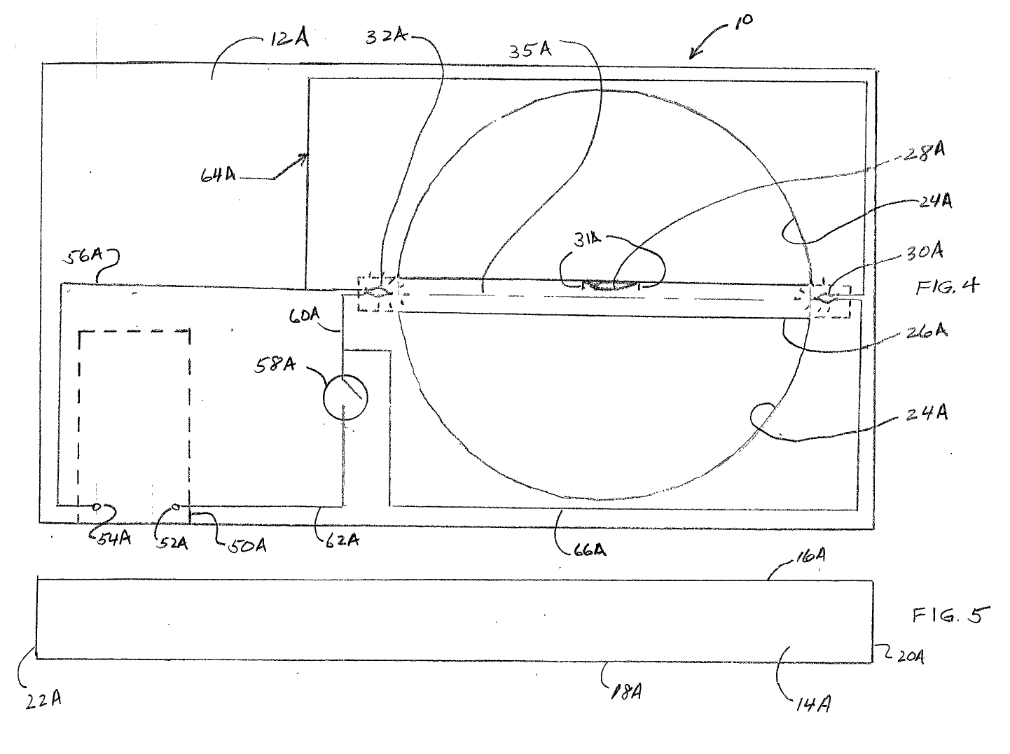

Referring initially to FIGS. 1, 2, and 3, the preferred embodiment of my spirit level system 10 is shown to comprise a frame 12 having a measuring surface 14 bounded by a forward measuring edge 16, a rear measuring edge 18, a right side measuring edge 20 and a left side measuring edge 22. The measuring surface 14 is substantially flat. It would be appreciated by those skilled in the art that the bottom measuring surface 14 need not be a rectangle but may be a square, ellipse or other shape provided it is substantially flat.

Within the frame 12 of the preferred embodiment, there is located a primary observation opening bounded by primary observation surface 24. Within primary observation surface 24 there is located primary observation tube 26. As discussed below, the primary observation tube 26 is sufficiently filled with a liquid so that a positioning bubble is present. The primary observation tube 26 is mounted within the primary observation surface 24 such that each end of the primary observation tube is affixed to the frame 12. The longitudinal axis of the primary observation tube 26 is parallel to the measuring surface 14 and perpendicular to right measuring surface 17.

At each end of the primary observation tube 26 there is located one or more light sources 30, 32. When the light sources are energized (as discussed below) they illuminate the liquid within the observation tube, thereby enabling the user to easily see the positioning bubble within the tube 26.

There is also located within the frame a secondary observation opening formed by secondary observation surface 34. Located within the volume bounded by secondary observation surface 34 is a secondary observation tube 36 which contains a liquid. The level of liquid within the secondary observation tube 36 is such that there is formed within the secondary observation tube 36 a second positioning bubble. The secondary observation tube is generally cylindrical with a first and second end. Each end of the secondary observation tube is affixed to the frame 12 such that the longitudinal axis of the secondary observation tube 36 is perpendicular to the bottom measuring surface 14 and parallel to right measuring surface 17.

As will be appreciated by those skilled in the art, additional observation tubes such as tertiary observation tube 40 may be located within a cavity formed by tertiary observation surface 42. The tertiary observation tube 40 is affixed at each end to the frame 12. The longitudinal axis of the tertiary observation tube 42 is at predetermined angles relative to the measuring surface 14 and the right measuring surface 17. However, in a preferred embodiment of my invention, the longitudinal axis of the tertiary observation tube 40 is at a forty-five degree angle to the measuring surface 14 and right measuring surface 17.

Those skilled in the art will be aware that the observation tubes may be located at other predetermined angles relative to the measuring surface 14 and right measuring surface 17 and that my indication of particular angles above is not meant as a limitation to my invention but such specific examples are given for purposes of example.

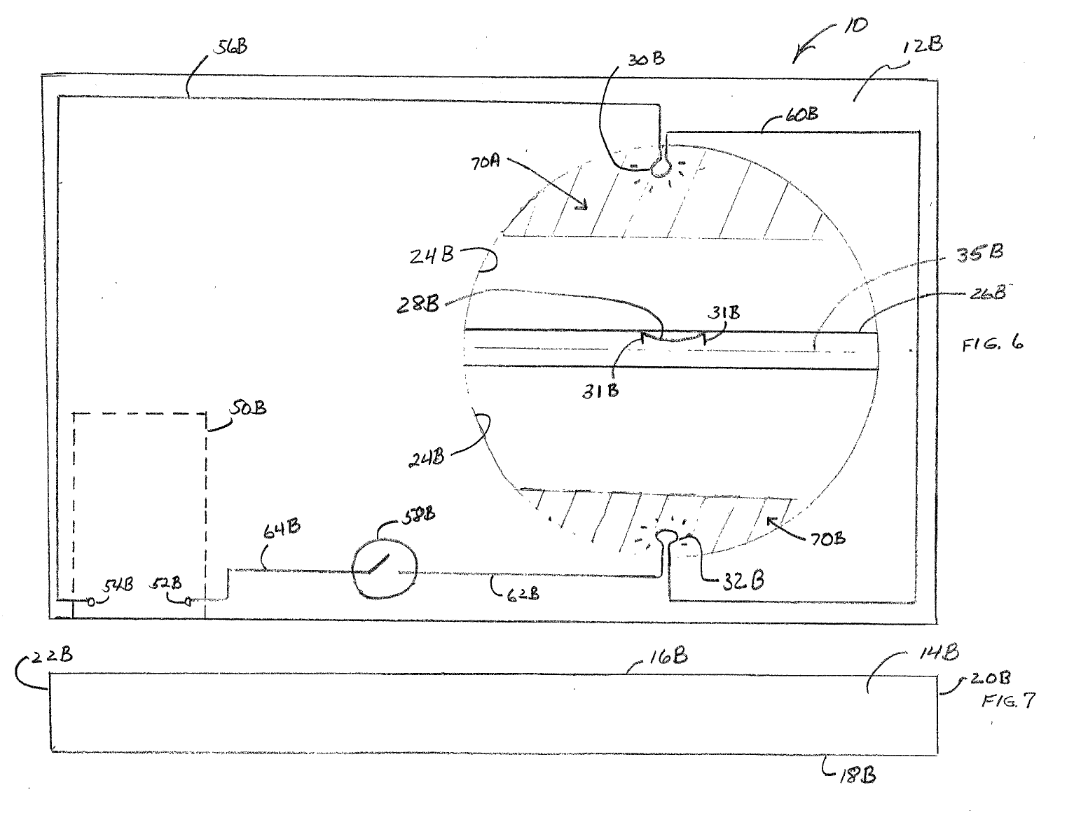

Next referring to FIG. 4 and FIG. 5, there is shown a preferred embodiment of my invention in partial diagrammatic form. My spirit level system 10 is comprised of a frame 12A having a bottom measuring surface 14A. The bottom measuring surface 14A is bounded by forward measuring edge 16A, rear measuring edge 18A, right side measuring edge 20A and left side measuring edge 22A. The frame 12A has an opening bordered by primary observation surface 24A. There is located within this opening a primary observation tube 26A which is generally cylindrical in shape. Primary observation tube 26A contains a liquid which substantially fills the primary observation tube. However, the liquid does not completely fill the tube and there is the presence of a small positioning bubble formed by the liquid surface 28A. At each end of the primary observation tube 26A there are located light sources such as light bulbs or light emitting diodes 30A and 32A. It will be appreciated by those skilled in the art that it is not necessary to have a light source at each end of the primary observation tube, but that two light sources are shown because this is the preferred embodiment of my invention.

The longitudinal axis 35A of the primary observation tube 26A is parallel to the bottom measuring 14A and perpendicular to the right measuring surface (not shown). Thus, when the bottom measuring surface 14A (and consequently forward and rear measuring edges 16A and 18A) is horizontal, the longitudinal axis of the primary observation tube 26A will also be horizontal, and it will be understood by those skilled in the art that the positioning bubble formed by surface 28A will be centered in the primary observation tube 26A. In a preferred embodiment of my invention, there are indicia 31A on the primary observation tube which will be of a location such that when the longitudinal axis of the primary observation tube 26A is horizontal, the left and right edge of the bubble formed by surface 28A will be between the indicia 31A. Those skilled in the art will appreciate that the location of indicia on the primary observation tube 26A will aid in determining when the bubble is centered within the primary observation tube.

There is also located within the frame 12A a power source such as battery 50A having terminals 52A and 54A. The battery 50A is shown in dashed lines as in a preferred embodiment it is located within the frame 12A. The battery 50A is part of a circuit which is capable of energizing light sources 32A and 30A. Terminal 54A is connected to a first terminal of light source 32A by means of conductor 56A. The second terminal of light source 32A is connected to a first terminal of switch 58A by means of conductor 60A. The second terminal of the switch 58A is connected to the terminal 52 A of the battery 50A by means of conductor 62A. Thus, as will be understood, when the switch 58A is in the closed position current will flow from terminal 54A through conductors 56A, light source 52A, switch 58A and conductor 62A and terminal 52A. Thus, the current will energize light source 32A which will glow and the liquid in the primary observation tube 26A will be illuminated. The user will thus be in a position to determine if the bubble formed by surface 28A is located between the indicia 31A.

In the embodiment in which I utilize two light sources for my invention, secondary conductors 64A and 66A are connected to each of the terminals of light source 38A. A first end of conductor 64A is connected to terminal 54A either directly or through conductor 56A. A first end of conductor 66A is connected to the first terminal of switch 58A such that when switch 58A is in the closed position, current will flow through conductor 66A and 64A and energize light source 30A. Similarly, when switch 58A is in the open position, no current will flow through light source 30A (or light source 32A).

It will be understood that the switch 58A may be a type generally known whereby it will only remain in the closed position for a predetermined length of time. In use, this will eliminate the problem which may arise if the user inadvertently leaves the switch in the closed position. This is to be avoided because it will drain the battery 50A and the life of the battery 50A will be reduced.

Referring next to FIGS. 6 and 7 there is shown my spirit level system 10 comprised of a frame 12B. The frame 12B has a measuring surface 14B formed by forward measuring edge 16B, rear measuring edge 18B, right side measuring edge 20B and left side measuring edge 22B. The measuring surface 14B is substantially flat and the four measuring edges 16B, 18B, 20B, and 22B are substantially straight.

There is formed within the frame 12B a primary observation surface 24B in which a primary observation tube 26B is positioned. As set forth above, the primary observation tube 26B is structured and manufactured in a conventional manner, that is, it is substantially filled with a liquid such that only a small positioning bubble is formed by the surface of the liquid 28B. The primary observation tube 26B also has indicia 31B to aid the user in determining if the positioning bubble is properly located.

The primary observation tube 26B has a longitudinal axis 35B which is at a predetermined angle relative to the measuring 14B. By way of example and not by way of limitation, in FIG. 6, the longitudinal axis 35B is parallel to the measuring surface 14B and perpendicular to right side measuring surface (not shown). It will be appreciated by those skilled in the art that the primary observation tube may be mounted so that its longitudinal axis is perpendicular to the measuring surface 14B or at some other predetermined angle.

Positioned laterally to the central portion of the primary observation tube 26B are two light sources such as bulbs or light emitting diodes 30B and 32B. It will be appreciated that a single bulb or light emitting diode mounted laterally to the central portion of the primary observation tube 26B will provide sufficient illumination to practice my invention. However, the use of two bulbs or light emitting diodes will improve the ability to observe the positioning bubble in the primary observation tube.

Located within the frame 12B is a power source such as battery 50B having positive terminal 52B and negative terminal 54B. An electric circuit is formed to energize the bulbs or light emitting diodes as follows. A conductor 56B has a first and connected to terminal 54B and a second end connected to a first terminal of bulb 30B. A second conductor such as wire 60B has a first end connected to the second terminal of bulb 30B and a second end connected to the first terminal of bulb 32B. A third conductor such as wire 63B has a first end connected to the second terminal of bulb 32B and a second end connected to the first terminal of switch 58B (which is shown in the open position) and a forth conductor 64B has a first end connected to the second terminal of switch 58B and a second end connected to terminal 52B of the battery 50B. When the switch 58B is placed in the closed position, electric current will flow from the battery through each of the bulbs 30B and 32B and illuminate each of the bulbs. When the switch 58B is in the open condition, no current will flow and the bulbs will not be eliminated. It will be appreciated that the switch 58B may be of the push button or of the toggle variety. A timer switch may also be utilized which will remain in the closed state for a predetermined amount of time and then revert automatically to the open state. This type of switch will aid the user and prevent the battery from being discharged because the user forgets to turn off the bulbs.

While I have shown my invention if FIG. 6 with the bulbs in a series circuit, it will be appreciated that the bulbs may also be connected to the battery 50B in a parallel configuration such as that shown in FIG. 4.

Also shown in FIG. 6 is shielding 70A and 70B. The shielding 70A and 70B is on the front and rear sides of the bulbs 30B and 32B. The purpose of the shielding is to direct the light from the bulbs 30B and 32B toward the primary observation tube 26B and to prevent the light emitted from the bulbs 30B and 32B from shining directly into the eyes of the user, i.e., it is present to prevent a direct visual path from the bulbs 30B and 32B to the eyes of the user. If the light from the bulbs 30B and 32B is allowed to shine into the eyes of the user it will be more difficult to see the positioning bubble formed by surface 28B and indicia 31B.

My invention is not to be taken as limited to all of the details described herein as modifications and variations thereof may be made without the departing from the spirit or scope of the invention.

Clearly what has been shown is a spirit level system which is simply constructed and inexpensive to manufacture and which is capable of being used accurately under conditions where there is no ambient light or the ambient light is at a low level.

Those skilled in the art will recognize that a great variety of liquids can be used in practicing the invention, including electro-luminescent and fluorescent liquids. I also recognize that numerous other modifications will be apparent to those skilled in the art who have the benefit of this description.

As previously stated, it is not my intention to limit the scope of my invention to the structure and details described with respect to my preferred embodiment. Rather, it is intended that my invention be defined solely by the claims appended hereto, and that these claims be interpreted as broadly as permitted by the prior art, with due regard being given to the Doctrine of Equivalence.

I claim as my invention:

1. An apparatus comprising:
a frame having a measuring surface;
an observation tube having a first end, a central portion and a second end and a longitudinal axis, the observation tube being filled with a liquid sufficient to create a positioning bubble within the observation tube and the observation tube mounted to the frame such that the longitudinal axis of the observation tube is at a predetermined angle relative to the measuring surface;
a first light source mounted to said frame in a position such that the light emitted from the first light source is directed at the observation tube;
an electric power source affixed to said frame and electrically connected to form a circuit with the first light source for energizing the first light source.

2. The apparatus of claim 1, wherein the first light source is located at the first end of the observation tube.

3. The apparatus of claim 1, wherein the first light source is located transverse to the longitudinal axis of the observation tube.

4. The apparatus of claim 2, including a second light source located at the second end of the observation tube and the second light source is electrically connected to the power source.

5. The apparatus of claim 2, including an electrical switch electrically connected in the circuit between the power source and the first light source to permit and prevent the flow of electric current between the power source and the first light source.

6. The apparatus of claim 4, including an electrical switch electrically connected to the power source and wherein the electrical switch forms a series circuit with the power source and the first and second light sources.

7. The apparatus of claim 6, wherein the first and second light sources form a series circuit with the power source.

8. The apparatus of claim 6, wherein the first and second light sources are connected in parallel with the power source.

9. The apparatus of claim 3, including a second light source electrically connected to the power source and mounted to the frame transverse to the longitudinal axis of the observation tube.

10. The apparatus of claim 9, wherein the first and second light sources are electrically connected in parallel with the power source.

11. The apparatus of claim 10, including an electrical switch mounted to the frame and electrically connected in a series circuit between the power source and the first and second light sources.

12. The apparatus of claim 11, wherein the longitudinal axis of the observation tube is parallel to the measuring surface.

13. The apparatus of claim 11, wherein the longitudinal axis of the observation tube is perpendicular to the measuring surface.

14. The apparatus of claim 6, wherein the observation tube is mounted to the frame such that the longitudinal axis of the observation tube is perpendicular to the measuring surface.

15. The apparatus of claim 11, including shielding means affixed to the frame for directing the light emitted from the first and second light sources.

16. The apparatus of claims 15, wherein the electrical switch includes timer means for automatically returning the electrical switch to the open position a predetermined time after it has been placed in the closed position.

17. The apparatus of claim 14, wherein the electrical switch includes timer means for automatically returning the switch to the open position a predetermined time after it has been placed in the closed position.

18. An apparatus comprising:
a frame having a flat measuring surface;
hollow observation tube means having a longitudinal axis and mounted to the frame means so that the longitudinal axis forms a predetermined angle with the measuring surface;
liquid means located within the observation tube means for filling the observation tube means so that a positioning bubble is formed within the observation tube means;
light source means mounted to the frame for illuminating the observation tube means;
power source means affixed to the frame and electrically connected to the light source means;
switch means mounted to the frame and electrically connected to the power source means and the light source means.

19. The apparatus of claim 18, wherein the observation tube means has a first and second end and the light source means is located at the first end of the observation tube means.

20. The apparatus of claim 18, wherein light source means is located traverse to the longitudinal axis of the observation tube means, and including shielding means affixed to the frame for directing the light emitted from the light source means to the observation tube means.
